(19) United States
(12) Patent Application Publication
(10) Pub. No.: US 2003/0133222 A1
(43) Pub. Date: Jul. 17, 2003

(54) Method and apparatus for sealing disc drives

(76) Inventors: Boon Seng Ong, Singapore (SG); Poh Lye Lim, Singapore (SG); Kelly MeiKee Lim, Singapore (SG); Niroot Jierapipatanakul, Singapore (SG)

Correspondence Address: Shawn B. Dempster, Seagate Technology LLC, Intellectual Property - SHK2LG, 1280 Disc Drive, Shakopee, MN, 55378-1863, US

(21) Appl. No.: 10/180,213

(22) Filed: Jun. 26, 2002

Related U.S. Application Data
(60) Provisional application No. 60/347,453, filed on Jan. 11, 2002.

(51) Int. Cl. G11B 17/02

(52) U.S. Cl. 360/97.02

(57) ABSTRACT

A disc drive is encapsulated by having a thermal bonding adhesive disposed between two housing components. The adhesive is selected for its ability to provide a sufficiently strong bond for forming sealed enclosure capable of withstanding a given external shock load applied to the disc drive. The sealing is effected without the need for mechanical fasteners coupling the two housing components.

### CROSS REFERENCE TO RELATED APPLICATIONS

This application claims benefit from U.S. Provisional Application No. 60/347,453, filed Jan. 11, 2002.

### FIELD OF THE INVENTION

The present invention relates generally to disc drives. More particularly, the present invention relates to an improved apparatus and method for sealing disc drives.

### BACKGROUND OF THE INVENTION

Disc drives are commonly used to store large amounts of data for easy retrieval. The conventional disc drive enclosure is generally made tip of a base deck and a cover fastened together by screws and other such fasteners. The housing provides a relatively clean and controlled environment in which the various disc drive components operate. Currently, a cover may be secured to the base deck by six or more screws threaded through holes in the cover and threadably engaging tapped holes in the base deck. During the manufacture of disc drives, the various components are mounted to the base deck before the cover is assembled thereto and the screw's driven in to complete the housing.

In the past, improvements to the sealing of disc drives have generally been directed towards providing gaskets and sealants in addition to the use of fasteners such as screws, to ensure that the cover will not be loosened from the base deck even when the disc drive is subject to a given maximum external shock load. Should the sealing fail, contaminants such as air borne particulates, acidic gases, and volitile organics will be able to enter easily into internal environment of the disc drive and damage the delicate components therein.

As conventional mechanical fasteners are well known to provide measurable and secure coupling, and with increasing precision required of the read/write process and the ever present pressure to improve overall drive performance, drive manufacturers invariably rely on mechanical fasteners (such as screws) as the primary coupler between the cover to the base deck. Methods that are based on the use of chemicals have been avoided for fear of outgassing. This is because it is generally believed that outgassing can contribute significantly to contamination in the internal environment of the disc drive, and may therefore adversely impact drive performance.

Yet, despite the general expectation that mechanical fasteners are necessary, alternative solutions are provided by the present invention that not only overcome the difficulties described above but also offer other advantages over the prior art.

### SUMMARY OF THE INVENTION

Embodiments of the present invention provides a method of effecting disc drive encapsulation. The method involves providing an adhesive to the first housing component, mating the first housing component with the second housing component to form an enclosure, and effecting an adhesive bond between the first housing component and the second housing component such that reinforcements to seal the enclosure are not necessary. The enclosure formed is one that is suitable for providing an internal environment within which a disc stack assembly and an actuator assembly may operate. This presents manufacturing advantages over the prior art since the tapping of holes and threading in of screws and other mechanical fasteners is a time-consuming part of disc drive manufacture.

The adhesive chosen is preferably one that is changeable between a less adhesive state and a more adhesive state. Thus, the adhesive may be provided in the less adhesive state on one of the two housing components to facilitate handling, and later changed to the more adhesive state after the two housing components have been properly aligned or mated. This further provides, additional advantages in that the adhesive may be changed back to the less adhesive state to allow the two housing components to be separated, thereby allowing access to the various disc drive components during rework. A disc drive relying solely on the adhesive to effect a sealed enclosure is further advantageous because of the opportunities for greater design flexibility. The two housing components need not be constrained by a need to allow for mechanical fasteners to be distributed along the length of the joint between the two housing components.

These and various other features as well as advantages which characterize the present invention will be apparent upon reading of the following detailed description and review of the associated drawings.

### BRIEF DESCRIPTION OF THE DRAWINGS

FIG. 1 is a top view of a conventional disc drive.

FIG. 2 is a partially exploded isometric view of a disc drive according to one embodiment of the present invention.

FIG. 3 is a partial cross-sectional view of the disc drive of FIG. 2.

FIG. 4 is a partially exploded isometric view of a disc drive according to one embodiment of the present invention.

FIG. 5 is a partial cross-sectional view of the disc drive of FIG. 4.

FIG. 6 is a flow-chart showing a method of sealing a disc drive according to one embodiment of the present invention.

### DETAILED DESCRIPTION

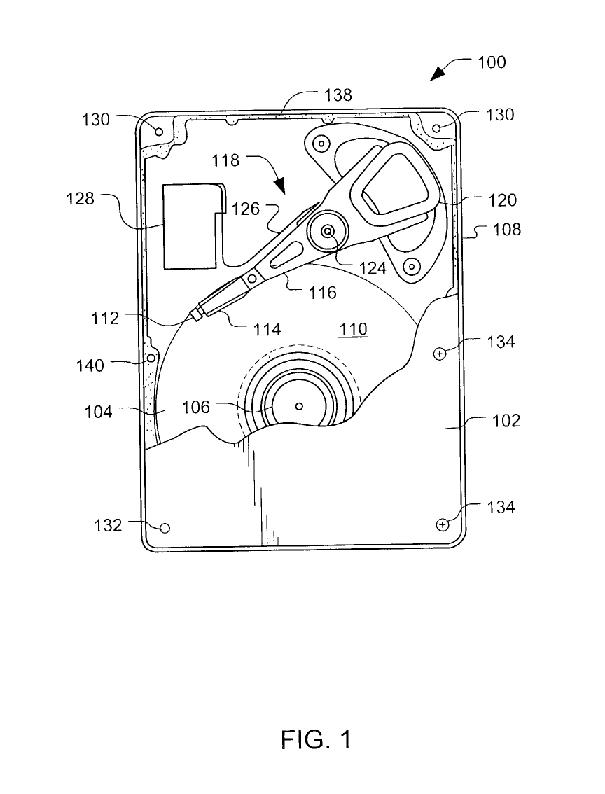

FIG. 1 shows a top view of a conventional disc drive 100 with the cover 102 partially cut-away to reveal the components in the disc drive 100. There is typically one or more discs 104 mounted to a spindle motor 106 that is in turn mounted to the base deck 108. Data is read from or written to the disc surfaces 110 by read/write heads 112 supported by a suspension 114 extending cantilever-fashion from one or more actuator arms 116 of an actuator assembly 118. The actuator assembly 118 supports a voice coil 120 in proximity to one or more permanent magnets 122 such that when a current is provided to the voice coil 120, the actuator assembly 118 is motivated to rotate about its pivot 124 and thereby controllably position the read/write heads 112 with respect to data tracks on the disc surfaces 110. Flexible circuit cables 126 run from the read/write heads 112 to a printed circuit board assembly (hidden from view) attached to the base deck 108 via a connector 128. The base deck 108 is provided with tapped holes 130 corresponding to holes 132 in the cover 102, and these two housing components 102,108 are joined together by fasteners 134 such as screws to create a sealed enclosure 136. In the example shown, six fasteners 134 distributed about the perimeter of the cover 102 are used to ensure that the disc drive 100 is properly sealed. A gasket 138 may sometimes be located between the base deck 108 and the cover 102 to improve the seal. The gasket 138 is provided with holes 140 for the fasteners 134 to pass through in order that the gasket 138 may be held in place together with the cover 102 and the base deck 108.

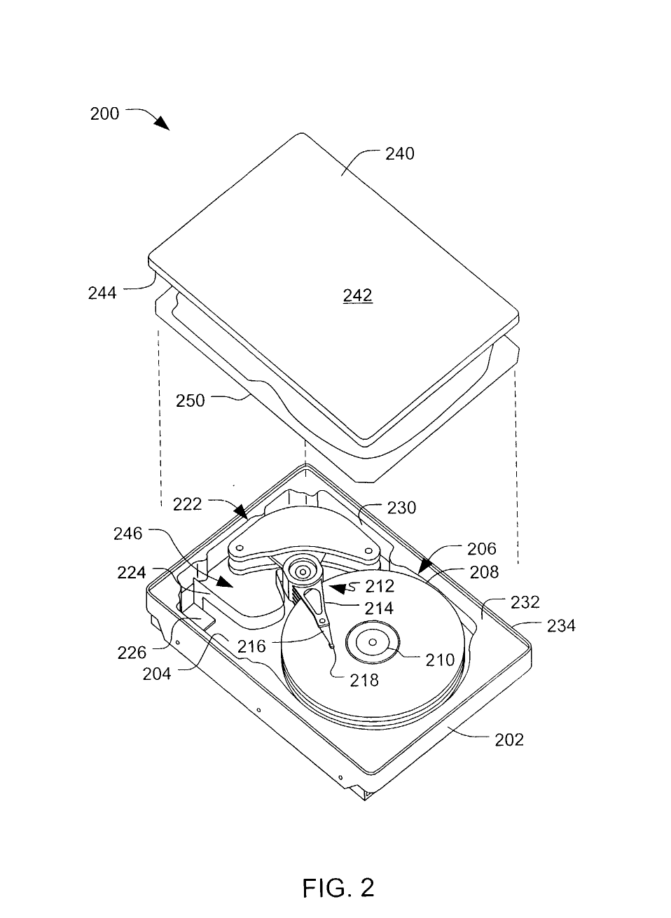

FIG. 2 is a partially exploded isometric view of a disc drive 200 according to one embodiment of the present invention. The base deck 202 provides a major surface 204 for the mounting of a disc stack assembly 206 formed by a plurality of discs 208 carried by a spindle motor 210. An actuator assembly 212 is shown with its array of actuator arms 214, suspensions 216 and read/write heads 218 interleaved with the discs 208. The voice coil is substantially hidden from view, but it will be understood that it is sandwiched between pole plates 220 to close the magnetic flux associated with the voice coil motor 222. Also shown is a flexible circuit cable 224 leading from the actuator assembly 212 to a connector 226 in communication with a printed circuit board hidden from view under the base deck 202.

Around the perimeter of the major surface 204 of the base deck 202 runs a wall 230 substantially transverse to a base plane that is defined by the major surface 204 of the base deck 202. The wall 230 includes a shelf 232 offering a surface substantially parallel to the base plane. The wall 230 may continue to extend further beyond the shelf 232, as shown, to form a skirting 234 around an outer boundary of the shelf 232.

The disc drive 200 includes a cover 240 shaped and sized to mate fittingly with the shelf 232 such that the cover 240 rests within the skirting 234. The cover 240 itself may be substantially flat such that in assembly with the base deck 204, the cover 240 is substantially parallel to the base plane. In assembly, the cover 240 presents an outer surface 242 to the environment external to the disc drive and an inner surface 244 to the internal environment 246 of the disc drive 200.

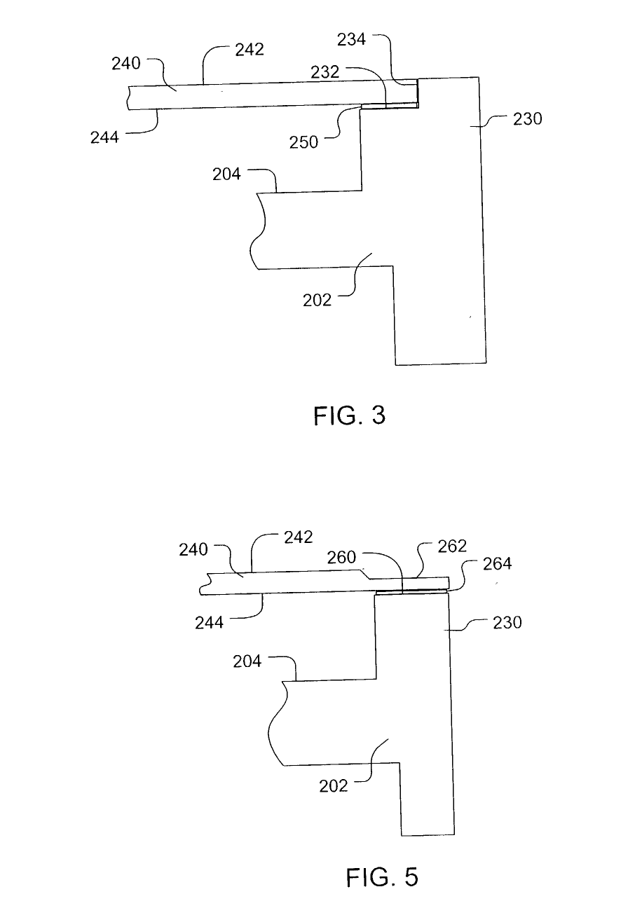

The cover 240 is attached to the base deck 202 without the aid of mechanical fasteners such as screws. Instead, an adhesive 250 is provided near the perimeter of the cover 240 such that, in assembly, the adhesive 250 is between the shelf 232 and the inner surface 244 of the cover 244, as illustrated by the cross-sectional schematic of FIG. 3. The adhesive 250 may be shaped or applied such that it varies in width along its length, as shown in FIG. 2. The cover 240 and the base deck 202 are in this fashion effectively bonded together (that is, the disc drive 200 is encapsulated) to provide a sealed enclosure within which the various disc drive components reside.

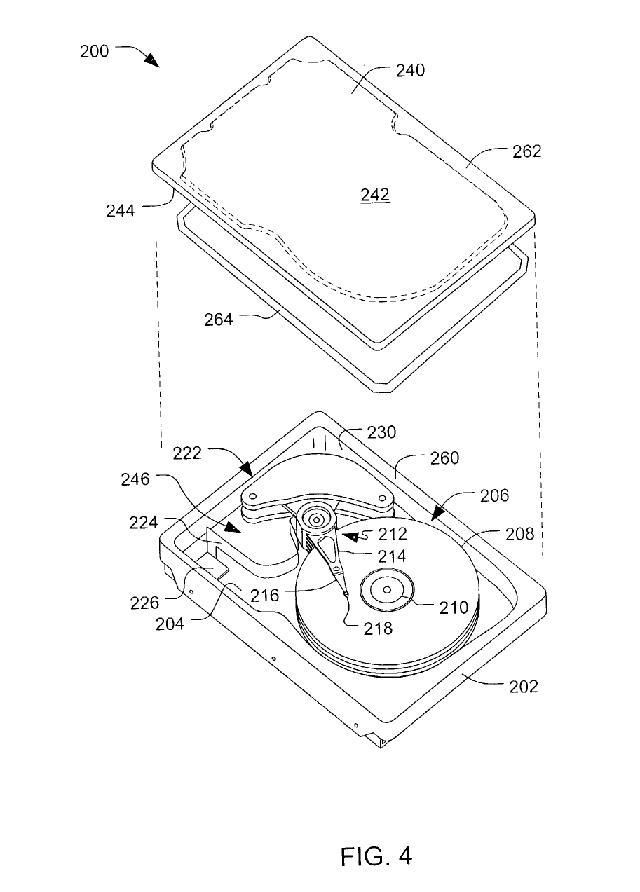

Referring to FIGS. 4 and 5, an alternative embodiment of the present invention is described. The wall 230 of the base deck 202 may optionally end in a terminal surface 260 without a further skirting or flange running around the perimeter. The width of the terminal surface 260 is such that it provides sufficient surface area for effective bonding with the inner surface 244 of the cover 240. The cover 240 shown here includes a flange or boundary portion 262 substantially complementary to the terminal surface 260. In assembly, an adhesive film 264 is located between the boundary portion 262 of the cover 240 and the terminal surface 260 of the base deck 202 such that the cover 240 and the base deck 202 are effectively bonded together to form a sealed enclosure.

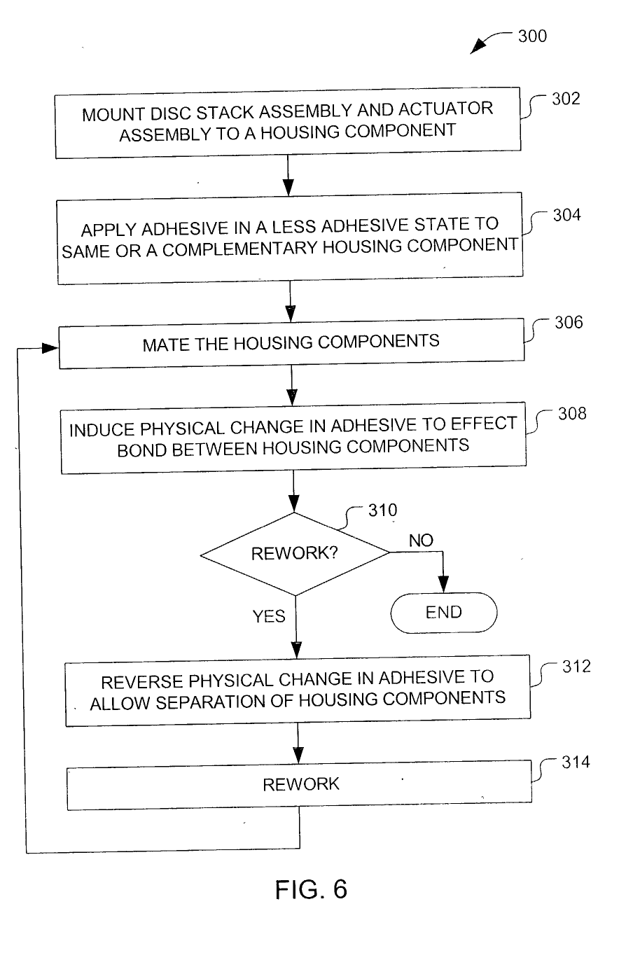

A method 300 of sealing a disc drive 200 according to one embodiment of the present invention is further described with reference to FIG. 6. A disc stack assembly 206 and an actuator assembly 212 are mounted to a base deck 202 of a disc drive 100 (step 302). An adhesive 250,264 is chosen from a family of thermoplastics that exhibit adhesive properties of variable strength and low outgassing characteristics, such as Thermo-Bond Films 668 and 668 EG available from 3MTM of Minnesota. The adhesive 250,264 can be first applied to either the cover 240 or the base deck 202 (step 304).

For example, the adhesive 250,264 may be a film cut to line the inner surface 244 of the cover 240 along its sides or its boundary portion 262. The entire cover 240 and adhesive 250,264 may be subject to tacking conditions where the adhesive 250,264 is made to adhere lightly to the cover 240. This may involve subjecting the cover 240 to pressure of about 10 pounds per square inch (psi) and temperature of around 70 degree Celsius for about 2 seconds, through the use of an oven or ultrasonic device. At the end of this tacking process, the cover 240 can be moved without the adhesive 250,264 dropping off. This easier handling is a manufacturing advantage, especially when compared to mechanical fasteners which could only be secured to either housing component after it is secured to both housing. The cover 240 can then be prepared in advance to reach the disc drive assembly line with the adhesive 250,264 already in place. The tacking conditions may optionally be applied locally, that is to say, only where the adhesive 250,264 is in contact with the cover 240.

Alternatively, the base deck 202 may be provided with the adhesive 250,264 lightly tacked on. For example, the adhesive 250,264 can be shaped to rest neatly on the terminal end 260 or a shelf 232 of the wall 230 of the base deck 202. The base deck 202 is then subjected to tacking conditions favorable to the formation of a bonds between the adhesive 250,264 and the base deck 202 (step 304). The disc stack assembly 206 and the actuator assembly 212 can then be mounted to the base deck 202 (step 302), or depending on the design of the assembly line, the various disc drive components can be assembled before or simultaneously as the adhesive 250,264 is applied to the base deck 202 (steps 302,304). A heated ring could be used to apply localized heating and pressure to effect the tacking.

Continuing with the description of the sealing process 300, the cover 240 and the base deck 202 are mated with the adhesive 250,264 in contact with both the inner surface 244 of the cover 240 and the wall 230 of the base deck 202 (step 306). The assembly is then subjected to bonding conditions conducive to the formation of stronger bonds between the adhesive 250,264 and the cover 240 and between the adhesive 250,264 and the base deck 202 (step 308). Such bonding conditions may be applied locally with the use of a heated ring or a hot shoe so as not to affect the other components of the disc drive 200. The bonding conditions may include a dwell time of about 15 seconds at a temperature of about 150 degree Celsius and pressure of about 20 psi. Comparatively, this may be more efficient than to drive in six screws in a conventional assembly of a disc drive.

Customer expectations of drive performance and reliability demand that certain requirements to be met. For example, a disc drive must be able to withstand a certain amount of external shock load without the cover becoming detached from the base deck or the seal between the cover and the base deck being broken. Tests were therefore conducted to confirm that the bond formed is suitable for use in a disc drive housing, especially to house a fully assembled disc drive having a disc stack assembly and actuator assembly mounted to the base deck. The peel strength was found to be at least 10 ounces for a 0.25 inch wide sample of adhesive that was tested after a 20-minute dwell time. To test the shear strength, a 250 gram weight was applied to an adhesion area of about 0.25 square inches for 24 hours at 60 degree Celsius. The adhesive was applied to a clean cover material. It was found that the creep did not exceed 0.125 as measured from a reference (top of the sample). Therefore, it was ascertained that using an adhesive alone can provide the required sealing strength without reducing the reliability of the disc drive. In addition to the fear that adhesives may generate unacceptable levels of outgassing, the traditional view is that an adhesive alone could not provide proper sealing of a disc drive. Unexpectedly, the contrary is found. Tests conducted showed that certain acrylic adhesives (such as ×4643 and ×4615 from Avery Dennison) would be suitable because they have acceptably low outgassing properties. Other types of adhesives which may be used include TH 434 (epoxy/propylene based) and TH 496 (polyester based) materials from Alcan, as well as some polyolefin and EVAs (ethylene vinyl acetates).

In the event that rework of a disc drive is desired (decision 310), the housing components 202,240 are again subjected to elevated temperatures to soften the adhesive 250,264. The housing components 202,240 can then be separated for access to the disc drive components housed therein. This is made possible by the choice of an adhesive 250,264 that does not undergo curing during heating or aging. Examples of a suitable adhesive include thermoplastics such as that described above. In this and other aspects, the present invention offers advantages over the prior art by providing for a bond between the cover and the base deck such that mechanical fasteners are superfluous to the proper sealing of the disc drive.

Other advantages that may follow in the wake of doing away with mechanical fasteners include the possibility of making smaller disc drives as well as allowing greater flexibility in the design of the housing components, since allowance for mechanical fasteners will not be essential. Possibly the base deck can be manufactured at lower cost because there is now no necessity to provide tapped holes in the base deck.

Alternatively described, one embodiment of the present invention involves providing an adhesive (such as 250,264) to the first housing component (such as 202,240; such as step 304), mating the first housing component (such as 202,240) with the second housing component (such as 202,240) to form an enclosure (such as step 306), and effecting an adhesive bond between the first housing component (such as 202,240) and the second housing component (such as 202,240) such that reinforcements to seal the enclosure are not necessary (such as step 308).

The method 300 may include mounting a disc stack assembly (such as 206) to a selected one of the first housing component (such as 202,240) and the second housing component (such as 202,240), and also mounting an actuator assembly (such as 212) to the selected housing component (such as 202,240; such as step 302). Optionally, a step (such as step 304) of subjecting the first housing component (such as 202,240) and the adhesive (such as 250,264) to tacking conditions favorable to formation of an initial bond between the first housing component (such as 202,240) and the adhesive (such as 250,264) may be performed. The tacking conditions may include a dwell time of about 2 seconds at temperature of about 70 degree Celsius and pressure of about 10 psi. The method may further involve a step (such as 308) of subjecting the first housing component (such as 202,240), the second housing component (such as 202,240) and the adhesive (such as 250,264) to bonding conditions favorable to formation of a final bond between the adhesive (such as 250,264) and the first housing component (such as 202,240) and between the adhesive (such as 250,264) and the second component (such as 202,240). The bonding conditions may include a dwell time of about 15 seconds at temperature of about −150 degree Celsius and pressure of about 10 psi. The adhesive (such as 250,264) may be one that is changeable between a less adhesive state and a more adhesive state. The adhesive (such as 250,264) may be a thermoplastic.

Another embodiment of the present invention provides a disc drive (such as 200) having a sealed enclosure formed by a method (such as 300) described in the foregoing.

Yet another embodiment of the present invention provides a disc drive (such as 200) having a first housing component (such as 202,240), a second housing component (such as 202,240), and an adhesive (such as 250,264) disposed between the first housing component (such as 202,240) and the second housing component (such as 202,240), where the adhesive (such as 250,264) provides the only bonding mechanism between the first housing component (such as 202,240) and the second housing component (such as 202,240). Optionally, the first housing component (such as 202,240) and the second housing component (such as 202,240) are complementarily mated to form a sealable enclosure for housing disc drive components (such as 206, 212).

It is to be understood that even though numerous characteristics and advantages of various embodiments of the present invention have been set forth in the foregoing description, together with details of the structure and function of various embodiments of the invention, this disclosure is illustrative only, and changes may be made in detail, especially in matters of structure and arrangement of parts within the principles of the present invention to the full extent indicated by the broad general meaning of the terms in which the appended claims are expressed.

What is claimed is:

1. A method of sealing a disc drive, the method comprising steps of:
(a) providing an adhesive to the first housing component;
(b) mating the first housing component with the second housing component to form an enclosure; and
(c) effecting an adhesive bond between the first housing component and the second housing component such that reinforcements to seal the enclosure are not necessary.

2. The method of claim 1 further comprising steps of:
mounting a disc stack assembly to a selected one of the first housing component and the second housing component; and
mounting an actuator assembly to the selected housing component.

3. The method of claim 1 in which the providing step (a) further comprises a step of subjecting the first housing component and the adhesive to tacking conditions favorable to formation of an initial bond between the first housing component and the adhesive.

4. The method of claim 3 in which the tacking conditions include a dwell time of about 2 seconds at temperature of about 70 degree Celsius and pressure of about 10 pounds per square inch.

5. The method of claim 1 in which the effecting step (c) further comprises a step of subjecting the first housing component, the second housing component and the adhesive to bonding conditions favorable to formation of a final bond between the adhesive and the first housing component and between the adhesive and the second component.

6. The method of claim 5 in which the bonding conditions include a dwell time of about 15 seconds at temperature of about 150 degree Celsius and pressure of about 10 pounds per square inch.

7. The method of claim 1 in which the adhesive is changeable between a less adhesive state and a more adhesive state.

8. The method of claim 7 in which the adhesive is a thermoplastic.

9. A disc drive having a sealed enclosure formed by the method of claim 1.

10. A disc drive comprising:
a first housing component;
a second housing component; and
an adhesive disposed between the first housing component and the second housing component, the adhesive providing the only bonding mechanism between the first housing component and the second housing component.

11. The disc drive of claim 10 in which the first housing component and the second housing component are complementarily mated to form a sealable enclosure for housing disc drive components.

12. A disc drive comprising:
a cover;
a base deck;
a disc stack assembly mounted to the base deck;
an actuator assembly mounted to the base deck adjacent the disc stack assembly; and
means for coupling the cover to the base deck to form a sealed enclosure within which the disc stack assembly and the actuator assembly are disposed.
